(19) United States
(12) Patent Application Publication
(10) Pub. No.: US 2015/0125408 A1
(43) Pub. Date: May 7, 2015

(54) Natural Insecticide Composition

(71) Applicants: Scott Kellar, Chicago, IL (US); Christine Kellar, Chicago, IL (US)

(72) Inventors: Scott Kellar, Chicago, IL (US); Christine Kellar, Chicago, IL (US)

(21) Appl. No.: 14/514,513

(22) Filed: Oct. 15, 2014

Related U.S. Application Data
(60) Provisional application No. 61/898,850, filed on Nov. 1, 2013.

(51) Int. Cl. A01N 65/28; A01N 65/08; A01N 65/06; A01N 65/22; A01N 65/26

(52) U.S. Cl. CPC A01N 65/28; A01N 65/22; A01N 65/26; A01N 65/06; A01N 65/08
USPC 424/59; 424/745

(57) ABSTRACT

The present invention disclosed herein is directed to a natural insecticide composition. In one embodiment, the composition includes a mixture of essential oils and a cleanser medium such as soap, shampoo, and the like. In another embodiment, the composition includes a mixture of essential oils and a lotion medium. Preferably, the essential oils in the present composition include catnip oil, neem oil, cedarwood oil, rose geranium oil, and lemon eucalyptus oil. The essential oils can externally release a repelling agent to incapacitate or otherwise discourage the pests, such as ticks and mosquitos. The present invention provides a natural eco-friendly insecticide that is safe for use on skin and hair on humans, as well as animals.

### CROSS REFERENCE TO RELATED APPLICATION

This application claims the benefit of U.S. Provisional Application No. 61/898,850 filed on Nov. 1, 2013. The above identified patent application is herein incorporated by reference in its entirety to provide continuity of disclosure.

### BACKGROUND OF THE INVENTION

1. Field of the Invention

The present invention relates to a natural insecticide composition. More specifically, the present invention pertains to an insecticide composition that can be used as a cleanser such as soap, shampoo, or a lotion. The insecticide of the present invention destroys insects such as ticks and mosquitos, or other organisms harmful to animals and humans.

Insecticides are chemical substances that deter, incapacitate, kill, or otherwise discourage any pests from coming in contact with an object, a person, or an animal. Target pests can include insects, such as mosquitos, flies, and ticks, among others. Insects can cause nuisance, spread disease, or are disease vectors.
Insecticides include ovicides and larvicides used against insect eggs and larvae, respectively. Insecticides are used in agriculture, medicine, industry, and by consumers. Although insecticides have many benefits, insecticide use raises a number of environmental concerns. For instance, nearly all insecticides have the potential to significantly alter ecosystems. Insecticides may also reach water, air, and soil and cause pollution and contamination.

Additionally, some insecticides are toxic to humans and may cause acute and delayed health effects to those who are exposed. Exposure to insecticides is known to cause a variety of adverse health effects, ranging from simple irritation of the skin and eyes to more severe effects such as negatively impacting the nervous system, damaging reproductive organs, and causing cancer. Thus, it is important to use natural insecticides, organic insecticides, or plant incorporated insecticides that are safe for topical application.

The present invention provides an insect repellant composed of natural ingredients. The composition consists essentially of a mixture of catnip oil, neem oil, cedarwood oil, rose geranium oil, and lemon eucalyptus oil in a cleanser or a lotion medium. It is contemplated that the cleanser medium may comprise a soap, a shampoo, or a conditioner, among others. Additionally, the lotion medium may comprise a face lotion, a body lotion, or a sun block, among others. The cleanser or the lotion medium may be in a liquid, gel, or solid form, depending upon embodiment. The composition is safe for topical application. In this way, the composition can be applied directly to skin or hair to clean or condition the skin or hair in a usual manner. Thus, the primary advantage of the present invention is not only its composition of natural, organic ingredients, but its wide application of use.

2. Description of the Prior Art

Compositions have been disclosed in the prior art that relate to compounds in shampoos and soaps that are used as an insecticide, and in particular for repelling or killing ticks and mosquitos on the human body. These include compositions that have been patented and published in patent application publications. Some of these patents describe a composition of eucalyptus oil and at least one diluent such as isopropyl alcohol and water. Another patent describes an insect repellent solution comprising a combination of alkali metal bicarbonate particles, silica, and water. These formulations, however, do not disclose a cleanser or a lotion that is combined with catnip oil, neem oil, cedarwood oil, rose geranium oil, and lemon eucalyptus oil.

The following is a list of formulations deemed most relevant to the present disclosure, which are herein described for the purposes of highlighting and differentiating the unique aspects of the present invention, and further highlighting the drawbacks existing in the prior art.

For example, U.S. Pat. No. 4,587,123 to Price discloses a composition for reducing pest infestation of animals, comprising eucalyptus oil, alcohol, and water. In one embodiment, the composition comprises approximately 4% to 22% of eucalyptus oil by weight, 9% to 33% of isopropyl alcohol by weight, and 45% to 85% water by weight. The composition can be topically applied to an animal to repel pests. In another embodiment, the composition may be added to a shampoo agent. Price, however, does not disclose a composition comprising catnip oil, neem oil, cedarwood oil, and rose geranium oil.

U.S. Published Patent Application No. 2013/0251775 to Palangie discloses a composition for killing lice. In one embodiment, the composition is in a gel form, and comprises 40% to 50% by weight of alkali metal bicarbonate, 15% to 25% by weight of silica, and 35% to 45% of water. While Palangie discloses a composition for killing lice, it is limited in the fact that it is not formulated to kill other insects or pests, such as mosquitos and ticks. The present invention provides a combination repellent and insecticide comprising essential oils and a cleanser or a lotion medium.

Similarly, U.S. Published Patent Application No. 2013/0225516 to Soll discloses a topical composition comprising 2 w/w % to 15 w/w % fipronil, 30 w/w % to 55 w/w % permethrin, and one or more neutral oils. The topical composition is used to repel stable fly. In contrast, the present invention discloses a composition that can repel and kill various types of insects, including ticks and mosquitos. Additionally, the present invention comprises a composition that includes a mixture of essential oils and a cleanser or a lotion medium.

Another device, U.S. Pat. No. 6,844,369 to Ninkov discloses a pesticidal compound comprising at least one organic phenolic compound and at least one salt comprising a divalent cation. Organic phenolic compound may comprise Carvacrol, thymol, or combinations thereof. While Ninkov discloses a compound that can prevent infestations of pests such as insects, mites, ova, fungus, or parasites, Ninkov does not disclose an insecticidal compound comprising essential oils combined with a lotion or a cleanser medium.

Finally, U.S. Published Patent Application No. 2007/0264297 to Scialdone discloses an insect repellent composition that comprises dihydronepetalactone, a nepetalactam, a dihydronepetalactam, and/or derivatives thereof. In some embodiments, the composition may further include adjuvants, modifiers, and additives. However, Scialdone does not disclose a shampoo, a conditioner, a soap, and a lotion medium.

These prior art devices have several known drawbacks because the prior art devices have limited applications. None of the prior art references disclose a mixture of various types of essential oils with a cleanser or a lotion. The present invention discloses oil based insecticide composition, which contain a mixture of a cleanser or a lotion medium that is combined with catnip oil, neem oil, cedarwood oil, rose geranium oil, and lemon eucalyptus oil. The formulation of such insecticide makes such composition effective for deterring and killing a wide variety of pests such as ticks and mosquitos, among other types of insects. Moreover, the preparation of the present composition does not require extensive synthesis of each of the ingredients, prolonged period of stirring, or exposure to extreme temperatures.

It is therefore submitted that the present invention substantially diverges in design elements from the prior art, which overcomes the disadvantages of the prior art devices, and consequently it is clear that there is a need in the art for an improvement to existing insect repellant compounds. In this regard the instant invention substantially fulfills these needs.

### SUMMARY OF THE INVENTION

In view of the foregoing disadvantages inherent in the known types of insect repellant compounds now present in the prior art, the present invention provides a new improvement to a natural insecticide composition wherein the same can be utilized for deterring, incapacitating, killing, or otherwise discouraging any pests such as insects and parasites.

It is therefore an object of the present invention to provide a new and improved natural insecticide composition that has all of the advantages of the prior art and none of the disadvantages.

It is another object of the present invention to provide a new and improved pesticide composition that comprises natural and organic ingredients.

Another object of the present invention is to provide a new and improved natural insecticide composition that is free of common skin and respiratory irritants such as dyes and synthetic fragrances.

Yet another object of the present invention is to provide a new and improved natural insecticide composition that is readily biodegradable and made from renewable sources.

Still yet another object of the present invention is to provide a new and improved natural insecticide composition that comprises various types of essential oils, including catnip oil, neem oil, cedarwood oil, rose geranium oil, and lemon eucalyptus oil.

Still yet another object of the present invention is to provide a new and improved natural insecticide composition that may comprise a cleanser medium, such as a soap, a shampoo, a conditioner, and the like.

Still yet another object of the present invention is to provide a new and improved natural insecticide composition that may comprise a lotion medium, such as a body lotion, a sun block, and the like.

Other objects, features and advantages of the present invention will become apparent from the following detailed description.

### DETAILED DESCRIPTION OF THE INVENTION

For the purposes of presenting a brief and clear description of the present invention, the preferred embodiment will be discussed as used for utilized for deterring, incapacitating, killing, or otherwise discouraging any pests such as insects and parasites.

In one embodiment, the insecticidal composition of the present invention is a mixture comprising a cleanser medium that is combined with various types of essential oils. In a preferred embodiment, the essential oils include catnip oil, neem oil, cedarwood oil, rose geranium oil, and lemon eucalyptus oil. Equal amounts of each of the essential oils are combined so that all of the oils comprise approximately 10% by volume of the mixture and the cleanser medium comprises approximately 90% by volume of the mixture. Accordingly, 2% of catnip oil, 2% neem oil, 2% cedarwood oil, 2% rose geranium oil, and 2% lemon eucalyptus oil are included in the mixture.

Each of the essential oils is processed to preserve the integrity of the essential oils. Additionally, the essential oils may be Grade A pure therapeutic quality or Grade B food grade quality. It is preferred, however, to use a Grade A quality oil is used as the purpose and intent of the present invention is to use a natural ingredient in purest form.

Catnip oil is produced from Nepeta cataria of the Lamiaceae family. The main chemicals in catnip oils are nepetalactones, consisting primarily of two isomers and caryophyllene. Catnip oils can be used as an effective insect repellant when used as an unfractionated essential oil due to the presence of both nepetalactone isomers and other components such as caryopyllene. Similarly, neem oil contains insect repellent and insecticide effects, and it is used for preparing cosmetics, including soap, hair products, body hygiene creams, and hand creams. Neem oil is not known to be harmful to mammals, and can be used as a household pesticide for mosquitos, bedbugs, fleas, among others. Neem oil also controls mildew and fungi.

Cedarwood oil is extracted through the process of steam distillation from the wood pieces of the cedar wood tree. The health benefits of cedarwood essential oil can be attributed to its properties as an antiseborrheic, antiseptic, antispasmodic, tonic, astringent, diluretic, emenagogue, expectorant, insecticidal, sedative, and fungicidal substance. Lemon eucalyptus oil also contains insect repellant properties. Lemon eucalyptus oil comprises eucalyptol, which has and can externally release a repelling agent.

Rose geranium oil is a calming agent, and has ability to reduce inflammation and irritation, and improve the health of the skin. The oil is extracted through steam distillation of stems and leaves of the geranium plant. Thus, the rose geranium oil is beneficial in the treatment of various types of skin conditions caused from insect bites. When added to a cleanser medium, the oil can help alleviate the skin and the scalp.

The cleanser medium may comprise a soap, a shampoo, a conditioner, including a leave-in conditioner, and the like. The cleanser medium may be in a liquid, a gel, or a solid form. Preferably, the cleanser medium may be scentless so that it does not interfere with the scent from the essential oils. It is contemplated that the aforementioned essential oils can be mixed with various types of soaps, shampoos, and conditioners without affecting the active ingredients of the soaps, shampoos, and conditioners. Thus, the composition of the present invention may be used in a usual manner in which soaps, shampoos, and conditioners are used. The exact composition of the cleanser medium is not of primary relevance with regard to the intent of the present invention, which portends to provide an improved insecticide comprising essential oils in a cleanser medium.

In another embodiment, the present invention discloses a mixture comprising a lotion medium that is combined with 2% by volume of catnip oil, 2% by volume of neem oil, 2% by volume of cedarwood oil, 2% by volume of rose geranium oil, and 2% by volume of lemon eucalyptus oil. Accordingly, the lotion medium may comprise approximately 90% of the mixture. The lotion medium may be a face lotion, a body lotion, a sun block, a suntan lotion, and the like. It is preferred that the lotion medium is unscented so that it does not overpower the scent from the essential oils. Similar to the first embodiment, the essential oils do not affect the active ingredients of the lotion medium, such that the lotion medium can be used in a usual manner. Additionally, the exact composition of the lotion medium is not of primary relevance with regard to the intent of the present invention, which portends to provide an improved insecticide comprising essential oils in a lotion medium.

Insects are naturally repulsed by the presence of the essential oils of the present composition. Accordingly, it is contemplated that the insects cannot build up a resistance to the present composition. When applied directly onto the skin or hair, the present composition is adapted to remove or extract insects such as ticks from the human body. Additionally, the present composition incapacitates and kills the insects on the human body.

A method for producing the natural insecticide composition of the present invention includes the steps of combining 2% by volume of catnip oil, 2% by volume of neem oil, 2% by volume of cedarwood oil, 2% by volume of rose geranium oil, and 2% by volume of lemon eucalyptus oil in a cleanser medium or lotion medium, wherein the cleanser or the lotion medium comprises approximately 90% by volume of the composition. This is generally accomplished by agitating the mixture until the essential oils and the medium are uniformly mixed. Optionally, the medium may be slightly heated prior to adding the essential oils to facilitate mixing. Thereafter, the mixture may be cooled and bottled or packaged. The mixture may then be kept at ambient temperatures of approximately 17° to 23° C.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A natural insecticide composition, consisting essentially of:
catnip oil in an amount of about 2.0% by volume;
neem oil in an amount of about 2.0% by volume;
cedarwood oil in an amount of about 2.0% by volume;
rose geranium oil in an amount of about 2.0% by volume;
lemon eucalyptus oil in an amount of about 2.0% by volume;
a medium in an amount of about 90.0% by volume.

2. The natural insecticide composition of claim 1, wherein said medium comprises soap.

3. The natural insecticide composition of claim 1, wherein said medium comprises a shampoo.

4. The natural insecticide composition of claim 1, wherein said medium comprises a conditioner.

5. The natural insecticide composition of claim 1, wherein said medium comprises a lotion.

6. The natural insecticide composition of claim 1, wherein said medium comprises a sun block.
